(19) United States
(12) Patent Application Publication
(10) Pub. No.: US 2009/0178961 A1
(43) Pub. Date: Jul. 16, 2009

(54) PAPER SHEET CONVEYING APPARATUS AND PAPER SHEET SORTING APPARATUS

(75) Inventor: Kazuya Saimei, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/210,596

(22) Filed: Sep. 15, 2008

(30) Foreign Application Priority Data
Jan. 10, 2008 (JP) 2008-003455

(51) Int. Cl. B07C 5/00

(52) U.S. Cl. 209/552; 271/270

(57) ABSTRACT

An apparatus according to the present invention is provided with a calculation device which calculates a period during which each of postal items passes through a predetermined section, based on time points of passage measured by inlet- and outlet-side measuring devices, individually, a comparison device which compares the passage period calculated by the calculation device with a required period for the passage through the predetermined section, and a control device which controls the operation of a gap correction device so as to vary the transfer speed of the postal items having passed through the outlet side, based on a comparative value obtained by comparison by the comparison device.

### CROSS-REFERENCE TO RELATED APPLICATIONS

This application is based upon and claims the benefit of priority from prior Japanese Patent Application No. 2008-003455, filed Jan. 10, 2008, the entire contents of which are incorporated herein by reference.

### BACKGROUND OF THE INVENTION

1. Field of the Invention

The present invention relates to a paper sheet conveying apparatus and a paper sheet sorting apparatus applicable to, for example, a mail sorter or the like.

2. Description of the Related Art

In a mail sorter or the like, postal items or letters are continuously picked up from a pickup portion and conveyed, addresses and the like on the conveyed postal items are read, and the postal items are sorted and stored into storage portions based on the read information.

Various postal items with different weights, sizes, etc., are picked up from the pickup portion. If the postal items are conveyed a great distance (e.g., through a transfer section of 50 m), therefore, transfer gaps between the postal items become so short that overtaking or the like occurs. Thus, the postal items may possibly fail to be conveyed with predetermined gaps therebetween.

Accordingly, the gaps between the postal items that are delivered from the transfer section are corrected by means of a gap correction device. A correction roller that is accelerated and decelerated by a servomotor or the like is used as the gap correction device.

The gaps between the paper sheets are corrected in the following manner.

First, gaps G1 and G2 between three postal items A, B and C are measured on the inlet side of the transfer section, as shown in FIG. 6A, for example, and they are measured again on the outlet side of the transfer section, that is, in a position just short of the gap correction device.

Let it be supposed that the gaps measured on the outlet side are changed individually into G1a and G2a, as shown in FIG. 6B. In the simplest example, the gaps are corrected by the gap correction device so that the gaps between the postal items A and B and between the postal items B and C become G1A and G2A, respectively, which are each calculated as (G1a+G2a)/2, and the postal items A and B are delivered in the manner shown in FIG. 6C (see Jpn. Pat. Appln. KOKAI Publication No. 6-127749, for example).

Conventionally, however, the gaps G1 and G2 measured on the inlet side of the transfer section are not considered as elements for correction. If the transfer is started with G1=100 mm and G2=100 mm, which are to be changed into G1a=30 mm and G2a=90 mm, respectively, in the position just short of the gap correction device, therefore, the corrected gaps G1A and G2A become (G1a+G2a)/2=60 mm each. Accordingly, the corrected gaps are arranged more closely than the inlet-side gaps, so that the postal items cannot be conveyed at regular intervals, thus failing to be sorted and stored satisfactorily.

### BRIEF SUMMARY OF THE INVENTION

The present invention has been made in consideration of these circumferences, and its object is to provide a paper sheet conveying apparatus and a paper sheet sorting apparatus, configured so that gaps between paper sheets on the inlet side of a predetermined section of a transfer path can be accurately reproduced to facilitate delivery of the paper sheets from the predetermined section.

An apparatus according to an aspect of the invention comprises a conveying device which conveys paper sheets at intervals along a transfer path, an inlet-side measuring device which measures time points of passage of the paper sheets conveyed by the conveying device on the inlet side of a predetermined section of the transfer path, an outlet-side measuring device which measures time points of passage of the paper sheets on the outlet side of the predetermined section, a gap correction device which corrects gaps between the paper sheets by varying a transfer speed of the paper sheets having passed through the outlet-side measuring device, a calculation device which calculates a period during which each paper sheet passes through the predetermined section, based on the time points of passage measured by the inlet- and outlet-side measuring devices, individually, a comparison device which compares the passage period calculated by the calculation device with a required period for the passage through the predetermined section, and a control device which controls the operation of the gap correction device so as to vary the transfer speed of the paper sheets having passed through the outlet side, based on a comparative value obtained by comparison by the comparison device.

An apparatus according to another aspect of the invention comprises a conveying device which conveys paper sheets at intervals along a transfer path, an inlet-side measuring device which measures time points of passage of the paper sheets conveyed by the conveying device on the inlet side of a predetermined section of the transfer path, an outlet-side measuring device which measures time points of passage of the paper sheets on the outlet side of the predetermined section, a gap correction device which corrects gaps between the paper sheets by varying a transfer speed of the paper sheets having passed through the outlet-side measuring device, a calculation device which calculates a period during which each paper sheet passes through the predetermined section, based on the time points of passage measured by the inlet- and outlet-side measuring devices, individually, a comparison device which compares the passage period calculated by the calculation device with a required period for the passage through the predetermined section, a control device which controls the operation of the gap correction device so as to vary the transfer speed of the paper sheets having passed through the outlet side, based on a comparative value obtained by comparison by the comparison device, a reading device which reads information on the paper sheets with the gaps corrected by the gap correction device, and a storage device which sorts and stores the paper sheets based on the information read by the reading device.

According to the present invention, the gaps between the paper sheets on the inlet side of the predetermined section of the transfer path can be accurately reproduced to facilitate delivery of the paper sheets from the predetermined section, so that the paper sheets can be sorted and stored satisfactorily.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a configuration view showing a mail processing machine according to one embodiment of the invention;

FIG. 2 is a view showing a gap correction device incorporated in the mail processing machine of FIG. 1;

FIG. 3 is an enlarged view showing a correction roller of the gap correction device of FIG. 2;

FIG. 4 is a block diagram showing a control system of the gap correction device of FIG. 2;

FIG. 5A is a diagram showing gaps between postal items on the inlet side of a predetermined section of a transfer path;

FIG. 5B is a diagram showing gaps between postal items which are varied during the transfer of the postal items in the predetermined section of the transfer path;

FIG. 5C is a diagram showing gaps between corrected postal items;

FIG. 6A is a diagram showing gaps between postal items on the inlet side of a predetermined section of a transfer path in prior art;

FIG. 6B is a diagram showing gaps between postal items which are varied during the transfer of the postal items in the predetermined section of the transfer path in prior art; and

FIG. 6C is a diagram showing gaps between corrected postal items in prior art.

### DETAILED DESCRIPTION OF THE INVENTION

Embodiments of the present invention will now be described in detail with reference to the accompanying drawings.

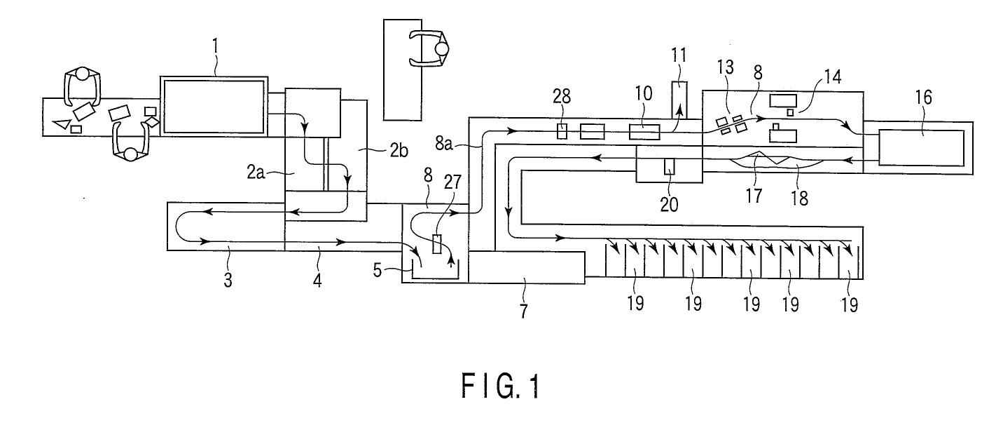

FIG. 1 is a plan view showing a mail processing machine according to one embodiment of the invention.

In FIG. 1, number 1 denotes a hopper, into which postal items as paper sheets are thrown. These postal items to be thrown into the hopper 1 are taken out of mailbags that are collected from postboxes and the like in the city or town. The postal items in the hopper 1 are mixed pieces including standard-size ones that can be machine-processed and non-standard-size ones that cannot.

A thickness discriminating portion 2a and a width discriminating portion 2b are connected to the hopper 1. The thickness and width discriminating portions 2a and 2b reject postal items with thicknesses greater than a predetermined thickness and non-standard-size ones and allow the passage of standard-size postal items only.

A staggering portion 3 for staggering superposed postal items is connected to the thickness and width discriminating portions 2a and 2b. The staggering portion 3 is connected with a one-sheet pickup portion 4 that picks up the postal items one by one. The one-sheet pickup portion 4 is connected with a buffer feeder unit 5 that stores and feeds the postal items. Further, the buffer feeder unit 5 is connected with a local feeder unit 7 for additionally feeding standard-size postal items that are aligned manually.

The buffer feeder unit 5 picks up the standard-size postal items one by one and delivers them in an upright position to a transfer path 8. The transfer path 8 incorporates an attitude control unit 10 that corrects the attitudes of the postal items. Provided on the mail delivery side of the attitude control unit 10 is a disposal portion 11 into which those postal items whose attitudes are not corrected are rejected.

Further, first and second reading devices 13 and 14 are arranged in the transfer direction of the postal items. Images of the respective obverse and reverse surfaces of the postal items that are not rejected into the disposal portion 11 are read by the first reading device 13. Subsequently, the images of the obverse and reverse surfaces are read by the second reading device 14 in like manner.

The unloading side of the second reading device 14 is connected with a switchback portion 16, which reorients the postal items based on the types of seals on the postal items and position information. The unloading side of the switchback portion 16 is connected with an inversion control portion 17, a normal-rotation control portion 18, and a cancellation portion 20. The inversion control portion 17 serves to turn the postal items upside down. The cancellation portion 20 is used to cancel seals on the postal items.

The unloading side of the cancellation portion 20 is connected with a plurality of storage portions 19, in which the postal items are sorted and stored based on read image information from the first and second reading devices 13 and 14.

The following is a description of a processing operation of the mail processing machine.

First, postal items are taken out of mailbags that are collected from postboxes and the like in the city or town and thrown into the hopper 1. The postal items in the hopper 1 are delivered to the thickness and width discriminating portions 2a and 2b, in which their thicknesses and widths are discriminated. Thereupon, postal items with thicknesses greater than the predetermined thickness and non-standard-size postal items with widths greater than a predetermined width are rejected, and only standard-size postal items are allowed to pass. If the standard-size postal items are superposed on one another, they are staggered in the staggering portion 3 and then picked up one by one by the one-sheet pickup portion 4. The picked-up postal items are fed to the buffer feeder unit 5. If there are any postal items to be additionally supplied, they are fed from the local feeder unit 7 into the buffer feeder unit 5. After this supply, the standard-size postal items are picked up one by one from the buffer feeder unit 5 and fed to the transfer path 8. The standard-size postal items thus fed to the transfer path 8 pass through the attitude control unit 10, whereby their transfer attitudes are corrected. Those postal items whose attitudes are not properly corrected are rejected into the disposal portion. The images of the respective obverse and reverse surfaces of the postal items that are not rejected are read by the first reading device 13. Subsequently, the images of the obverse and reverse surfaces are read by the second reading device 14 in like manner. After their images are read, the postal items are switched back to be reoriented in the switchback portion 16 or conveyed without being switched back. Then, the postal items are inverted in the inversion control portion 17 or passed through the normal-rotation control portion 18. Thus, the respective positions of the seals on the postal items are aligned and the seals are canceled in the cancellation portion 20. After this cancellation, the postal items are sorted and stored based on the image information read by the first and second reading devices 13 and 14.

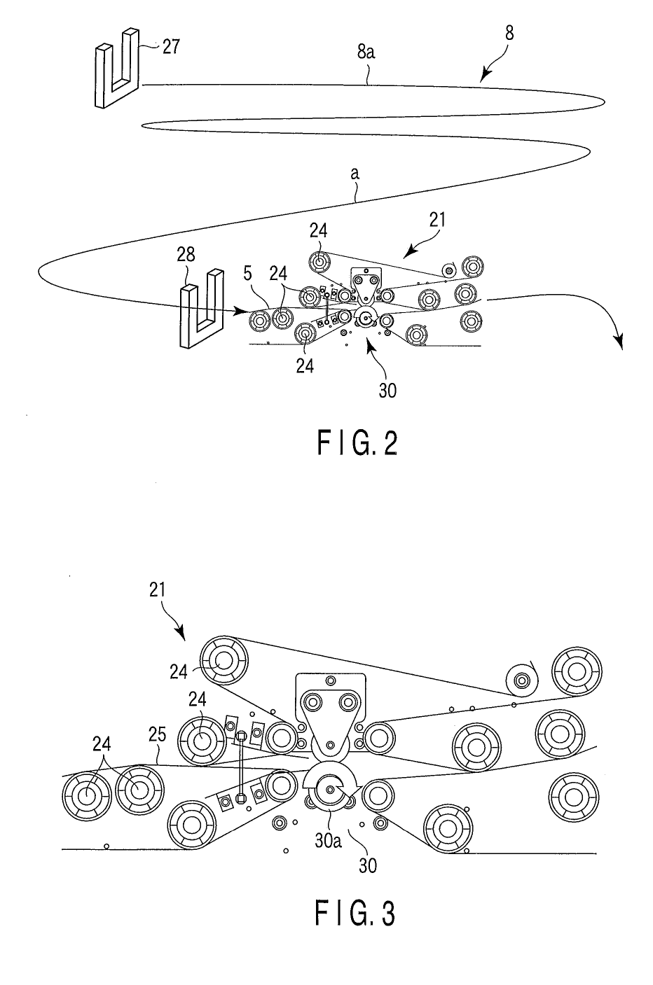

As also shown in FIG. 2, an inlet-side sensor 27 as an inlet-side measuring device is provided on the inlet side of a predetermined section 8a (e.g., as long as 50 m) of the transfer path 8 along which the postal items delivered from the buffer feeder unit 5 are conveyed. An outlet-side sensor 28 as an outlet-side measuring device is provided on the outlet side. The inlet- and outlet-side sensors 27 and 28 individually measure time points of passage of each postal item being conveyed.

The postal items are conveyed along the transfer path 8 by a conveying device 21. The conveying device 21 is composed of a plurality of rollers 24 and a conveyor belt 25 that are passed around and between the rollers 24 and holds and conveys the postal items.

Further, a gap correction device 30 is disposed on the downstream side of the outlet-side sensor 28. The device 30 controls the transfer speed of the postal items passed through the sensor 28, thereby correcting gaps between the postal items. The gap correction device 30 includes a correction roller 30a that is accelerated and decelerated by a servomotor, as also shown in FIG. 3.

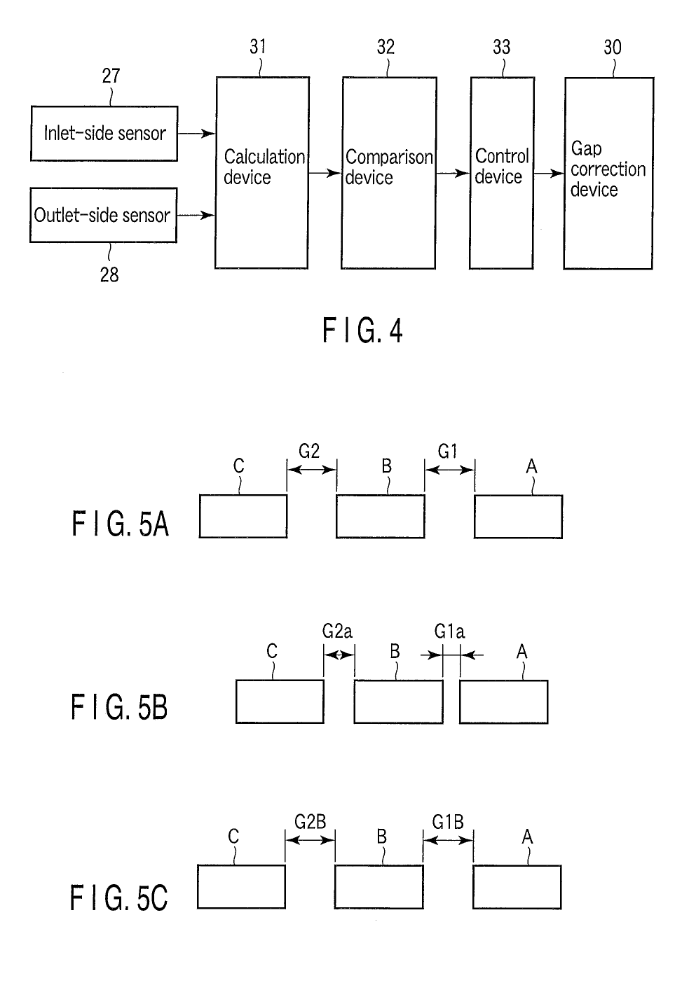

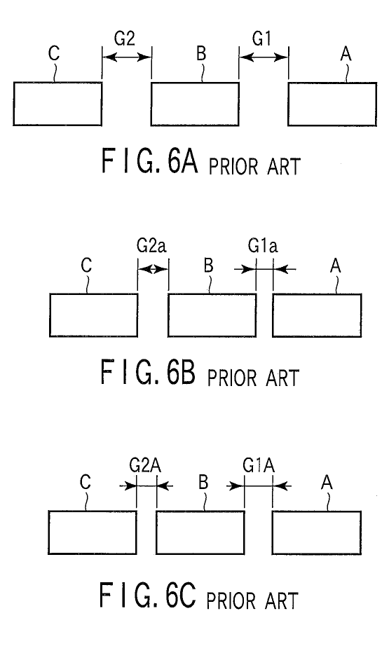

As shown in FIG. 4, on the other hand, the gap correction device 30 is connected to the inlet- and outlet-side sensors 27 and 28 through a calculation device 31, a comparison device 32, and a control device 33.

The calculation device 31 calculates a period during which each postal item passes through the predetermined section 8a, based on the time points of passage of the postal item measured by the inlet- and outlet-side sensors 27 and 28.

The comparison device 32 compares the period calculated by the calculation device 31 with a required period (theoretical value) for the passage through the predetermined section 8a.

The control device 33 controls the rotational speed of the correction roller 30a of the gap correction device 30 based on a comparative value obtained by the comparison device 32.

Specifically, if the period for the mail passage is greater than the predetermined period, the rotational speed of the correction roller 30a is increased to accelerate the transfer of the postal item. If the former is less, the rotational speed of the roller 30a is reduced to decelerate the postal item transfer.

Various postal items are conveyed. If the postal items are conveyed a great distance (50 m) along the predetermined section 8a of the transfer path 8, the transfer speed changes depending on differences between their respective weights, shapes, etc. Thus, the gaps between the postal items easily vary and they require correction.

The following is a description of the case of correction of the gaps between the postal items conveyed in the predetermined section 8a of the transfer path 8.

First, the time point of passage of each postal item through the inlet-side sensor 27 is measured by the sensor 27. The measured time point is transmitted to the calculation device 31. The postal item having passed through the inlet-side sensor 27 is conveyed along the predetermined section 8a and passes through the outlet-side sensor 28, whereupon the passage time point is measured by the sensor 28. The measured passage time point is transmitted to the calculation device 31.

The calculation device 31 calculates the required period for the passage of the postal item through the predetermined section 8a, based on the passage time points of the postal item transmitted individually from the inlet- and outlet-side sensors 27 and 28. The result of this calculation is transmitted to the comparison device 32, which then compares the calculated period with the required period (theoretical value) for the passage through the predetermined section 8a. The result of this comparison is transmitted to the control device 33, which then controls the rotational speed of the correction roller 30a of the gap correction device 30 based on the comparative value obtained by the comparison device 32. The rotational speed of the roller 30a is controlled so that the transfer of the postal item is accelerated if the period for the mail passage is greater than the predetermined period, and that the postal item transfer is decelerated if the calculated period is less, on the other hand.

Completion of this control indicates that the same distance is covered in the same period by all the postal items. Thus, if gaps G1 and G2 between postal items A, B and C on the inlet side of the predetermined section 8a, as shown in FIG. 5A, are changed into G1a and G2a, respectively, as shown in FIG. 5B, as the postal items A, B and C are conveyed in the predetermined section 8a, for example, the gaps become G1B (=G1) and G2B (=G2), respectively, as shown in FIG. 5C, after the gap correction device 30 is passed. Thus, the gaps created when the postal items A, B and C are delivered to the inlet side are reproduced on the outlet side, whereby satisfactory gap correction can be performed.

The gaps between the postal items that are conveyed along the transfer path 8 easily change as the postal items are conveyed a great distance. Even when the transfer distance is not great, however, the gaps between the postal items also easily change during passage through a section that is obstructive to the transfer, such as the switchback portion 16 or the inversion control portion 17. For more effective gap correction, therefore, it is advisable to locate the gap correction device 30 on the downstream side of an area in which the gaps between the postal items are liable to change, with respect to the transfer direction.

When compared with the conventional system in which the gap correction is locally performed based on the mutual gaps that are made irregular after transfer over a great distance, this embodiment is advantageous in that the state of the gaps on the inlet side of the predetermined section 8a can be reproduced at 100%, as described above.

If the gaps are already made irregular at the inlet of the predetermined section 8a, according to this embodiment, the irregular gaps are inevitably simultaneously reproduced on the outlet side. However, the degree of this irregularity ensures high reliability such that the postal items can be conveyed in the next equivalent section without involving overtaking or any other trouble, based on the last accomplishment of the postal item transfer in the predetermined section 8a.

Although the apparatus of this invention is configured to correct the transfer gaps, moreover, it actually requires no gap measurement. Thus, only the time points at which each postal item passes through the inlet and outlet of the predetermined section 8a are expected to be measured, so that the control is easy.

According to the conventional system, the gaps require actual measurement, so that at least two approaches are needed to control the paper sheets being conveyed, and hence, the control is complicated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A paper sheet conveying apparatus comprising:
a conveying device which conveys paper sheets at intervals along a transfer path;
an inlet-side measuring device which measures time points of passage of the paper sheets conveyed by the conveying device on the inlet side of a predetermined section of the transfer path;
an outlet-side measuring device which measures time points of passage of the paper sheets on the outlet side of the predetermined section;
a gap correction device which corrects gaps between the paper sheets by varying a transfer speed of the paper sheets having passed through the outlet-side measuring device;
a calculation device which calculates a period during which each paper sheet passes through the predetermined section, based on the time points of passage measured by the inlet- and outlet-side measuring devices, individually;
a comparison device which compares the passage period calculated by the calculation device with a required period for the passage through the predetermined section; and
a control device which controls the operation of the gap correction device so as to vary the transfer speed of the paper sheets having passed through the outlet side, based on a comparative value obtained by comparison by the comparison device.

2. A paper sheet conveying apparatus according to claim 1, wherein the gap correction device is provided with a correction roller with a variable rotational speed.

3. A paper sheet conveying apparatus according to claim 1, wherein the control device is configured to accelerate the transfer of the paper sheets by the gap correction device when the passage period of the paper sheets is greater than the predetermined period and to decelerate the transfer of the paper sheets by the gap correction device when the passage period of the paper sheets is less than the predetermined period.

4. A paper sheet conveying apparatus according to claim 3, wherein the gap correction device is provided with a correction roller with a variable rotational speed.

5. A paper sheet sorting apparatus comprising:
a conveying device which conveys paper sheets at intervals along a transfer path;
an inlet-side measuring device which measures time points of passage of the paper sheets conveyed by the conveying device on the inlet side of a predetermined section of the transfer path;
an outlet-side measuring device which measures time points of passage of the paper sheets on the outlet side of the predetermined section;
a gap correction device which corrects gaps between the paper sheets by varying a transfer speed of the paper sheets having passed through the outlet-side measuring device;
a calculation device which calculates a period during which each paper sheet passes through the predetermined section, based on the time points of passage measured by the inlet- and outlet-side measuring devices, individually;
a comparison device which compares the passage period calculated by the calculation device with a required period for the passage through the predetermined section;
a control device which controls the operation of the gap correction device so as to vary the transfer speed of the paper sheets having passed through the outlet side, based on a comparative value obtained by comparison by the comparison device;
a reading device which reads information on the paper sheets with the gaps corrected by the gap correction device; and
a storage device which sorts and stores the paper sheets based on the information read by the reading device.

6. A paper sheet sorting apparatus according to claim 5, wherein the gap correction device is provided with a correction roller with a variable rotational speed.

7. A paper sheet sorting apparatus according to claim 5, wherein the control device is configured to accelerate the transfer of the paper sheets by the gap correction device when the passage period of the paper sheets is greater than the predetermined period and to decelerate the transfer of the paper sheets by the gap correction device when the passage period of the paper sheets is less than the predetermined period.

8. A paper sheet sorting apparatus according to claim 7, wherein the gap correction device is provided with a correction roller with a variable rotational speed.
